(19) United States
(12) Patent Application Publication
(10) Pub. No.: US 2014/0033109 A1
(43) Pub. Date: Jan. 30, 2014

(54) ENHANCED VISUAL PROPERTIES OF BUSINESS OBJECT REPRESENTATIONS

(71) Applicants: Roy Ghorayeb, Montreal (CA); Xuebo Liang, Brossard (CA); Alain Gauthier, Montreal (CA); Mohannad El-Jayousi, L'Ile-Bizard (CA); Vincent Lavoie, Montreal (CA); Rolan Abdukalykov, Montreal (CA)

(72) Inventors: Roy Ghorayeb, Montreal (CA); Xuebo Liang, Brossard (CA); Alain Gauthier, Montreal (CA); Mohannad El-Jayousi, L'Ile-Bizard (CA); Vincent Lavoie, Montreal (CA); Rolan Abdukalykov, Montreal (CA)

(73) Assignee: SAP AG, Walldorf (DE)

(21) Appl. No.: 13/561,700

(22) Filed: Jul. 30, 2012

(51) Int. Cl. G06F 3/048

(52) U.S. Cl. 715/772

(57) ABSTRACT

Scale(s) on one or more axes may be displayed. The scale(s) may present a range of values associated with business object attribute(s). Visual representation(s) of business object(s) may be displayed. The visual representation(s) may be positioned relative to the scale(s). One or more visual properties of the visual representation(s) may be varied based on information associated with the business object(s). The one or more visual properties may be color(s) of the visual representation(s), pattern(s) in the visual representation(s), video(s) in the visual representation(s), text in the visual representation(s), image(s) in the visual representation(s), and/or shape(s) of the visual representation(s).

### BACKGROUND

Business software such as enterprise resource planning (ERP) software implements business processes by modeling business data as business objects (BOs) with data exchange between the BOs. The business data provided via BOs can be accessed through mechanisms such as graphical user interfaces (GUIs), forms, and analytical reports.

Traditionally, GUIs providing access to BOs conveyed limited information about the attributes associated with the BOs. In addition, the information presented by the GUIs were not customizable easily based on the needs of a user.

### BRIEF DESCRIPTION OF THE DRAWINGS

FIG. 1 illustrates a GUI to display BOs according to an embodiment.

FIG. 2 illustrates a GUI to display BOs according to an embodiment.

FIG. 3 illustrates a GUI to display BOs according to an embodiment.

FIG. 4 illustrates an exemplary interface to customize visual representations of BOs according to an embodiment.

FIG. 5 illustrates a window to display and/or modify attributes/metadata of BOs according to an embodiment.

FIG. 6 shows an exemplary architecture in an embodiment of the invention.

### DETAILED DESCRIPTION

Embodiments may be discussed in systems to efficiently display/modify information about BOs. In an embodiment, scale(s) on one or more axes may be displayed. The scale(s) may present a range of values associated with business object attribute(s). Visual representation(s) of business object(s) may be displayed. The visual representation(s) may be positioned relative to the scale(s). One or more visual properties of the visual representation(s) may be varied based on information associated with the business object(s).

In an embodiment, the one or more visual properties may be color(s) of the visual representation(s), pattern(s) in the visual representation(s), video(s) in the visual representation(s), text in the visual representation(s), image(s) in the visual representation(s), and/or shape(s) of the visual representation(s). In an embodiment, the one or more visual properties of the visual representation(s) may be varied based on a mapping which associates the one or more visual properties and value(s) of attribute(s) of the business object(s). In an embodiment, a visual key to indicate meaning(s) of the one or more visual properties may be displayed.

In an embodiment, scale(s) on one or more axes may be displayed. The scale(s) may present a range of values associated with business object attribute(s). Visual representation(s) of business object(s) may be displayed. The visual representation(s) may be positioned relative to the scale(s). In response to activation of the visual representation(s), window(s) presenting information associated with the business object(s) may be displayed. In an embodiment, the visual representation(s) may be activated via a touch screen.

Business software usually includes a standard set of BOs which can be utilized by the software user to model a business entity. For example, in an embodiment, business software may include BOs representing business entities such as business promotions (trade promotions), sales orders, sales quotes, customer quotes, service documents, business opportunities, etc. Each BO may include attributes which define metadata associated with the BO. For example, a business promotion BO may represent a business promotion offered by a first company through a second company to consumers. The first company may be a soft drink company and the second company may be a major retailer. The promotion may have a start date and an end date (a promotion period). The promotion may offer the product, for example, a soft drink, for the promotion period at a particular sale price. The business promotion BO may include attributes such as the name of the second company, the size of the second company, the type of the second company, the name of the promotion product, the sale price of the product during the promotion, the price of the product without the promotion, the quantity of the product sold during the promotion, the start date of the promotion, and the end date of the promotion.

Attributes of BOs may indicate a range of values. For example, in an embodiment, a business promotion BO may include one or more attributes indicating the time period for which the business promotion is valid. The time period may be implemented by either defining a single time period attribute associated with the business promotion BO or by defining a start date attribute and an end date attribute associated with the business promotion BO. Similarly, in another example embodiment, the business promotion may only apply if particular quantities of a product are purchased. Therefore, the business promotion BO may include one or more attributes indicating a range of quantities to which the business promotion applies to.

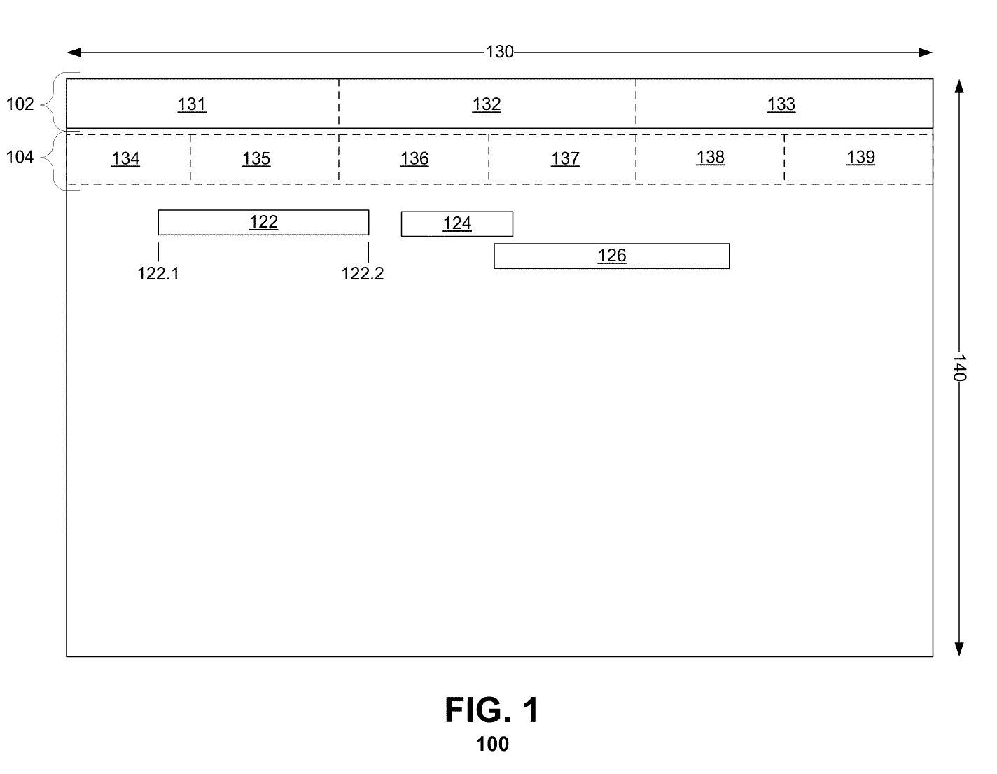

FIG. 1 illustrates a GUI 100 to display BOs according to an embodiment. In an embodiment, BOs may be displayed on a GUI 100 in an organized manner to visually convey information about the BOs. The GUI 100 may display one or more scales 102, 104 on the x-axis 130 and/or y-axis 140. The GUI 100 may display visual representations of BOs such as 122, 124, and 126 mapped in relationship to the attributes on the x-axis 130 and/or y-axis 140.

In an embodiment, the attribute(s) displayed across the x-axis 130 and/or y-axis 140 may be presented as one or more scales displaying attribute values (for example, 102 and 104). In an embodiment, if multiple scales are presented on a particular axis, each scale may be graduated based on different granularities. For example, scales 102 and 104 may represent time periods. Scale 102 may be graduated into year units. Specifically, each of 131, 132, and 133 may represent a year. Scale 104 may be graduated on a semi-annual basis. Specifically, 134-139 may each represent half of a year.

In an embodiment, there may be a correlation between the multiple scales on a particular axis. For example, there may be a correlation between the units of scale 102 and scale 104. Time period 131 on scale 102 may represent a particular year, such as year 2012. The time period 134 may represent the first half of the year 2012, and the time period 135 may represent the second half of year 2012. In an embodiment the correlated portions of multiple scales may be presented directly above/below (x-axis) or directly beside (y-axis) each other. For example, time period 131 may be located directly above/below corresponding time periods 134 and 135.

The scale(s) displayed on the x-axis and/or y-axis 102 and 104 may be a range of contiguous values and/or discrete values. For example, the scales 102 and 104 may represent a contiguous time period of three years, a contiguous price range between zero Canadian dollars and 30 Canadian dollars, a contiguous temperature range between 0 degrees Fahrenheit and 90 degrees Fahrenheit, etc. In another example, the scales 102 may represent discrete products such as car A (131), car B (132) and car C (133).

In an embodiment, one or more scales (not shown) may be presented on the y-axis 140. The y-axis scale(s) may be presented and function similar to the x-axis scale(s) described above. Although only two axes (x and y) are illustrated in FIG. 1, a person having ordinary skill in the art will appreciate that GUI 100 may be extended to display additional axes. For example, a z-axis (with corresponding scale(s)) may be displayed by utilizing shading to show the third dimension. In a further example, the z-axis (with corresponding scale(s)) may be presented by displaying GUI 100 on a display which is 3-dimension (3D) compatible.

In an embodiment, the BO(s) displayed on the GUI 100 may be positioned and presented based on respective attribute value(s) of the BO(s) relative to the x-axis and/or y-axis scale(s) of GUI 100. In an example embodiment, scale 102 may be displayed on the GUI 100 and may indicate a time period range as explained above. BOs 122, 124, and 126 may be visual representations of business promotion BOs. Each BO represented by 122, 124, and 126 may include attributes indicating the business promotion period of the respective business promotion BO. The BO visual representations 122, 124, and 126 may be presented to visually convey the span of the business promotion periods, and the start/end of the business promotion periods. For example, time periods 131, 132, and 133 may represent years 2012, 2013, and 2014 respectively. Business promotion BO 122 may have a business promotion period from April 14, 2012 to January 23, 2013. Thus, BO 122 may be presented as a horizontal bar extending from start point 122.1 positioned below time period 131 to end point 122.2 positioned below time period 132. The start point 122.1 may line up with a point in the time period 131 which approximately corresponds to April 14, 2012, and the end point 122.2 may line up with a point in the time period 132 which approximately corresponds to Jan. 23, 2013.

In an example embodiment, multiple scales 102 and 104 may be presented on the

GUI 100 and the BO visual representations 122, 124, and 126 may be presented relative to the multiple scales. For example, time periods 134, 135, and 136 may represent the first half of year 2012, the second half of year 2012, and the first half of year 2013 respectively. Business promotion BO 122 may have a business promotion period from Apr. 14, 2012 to Jan. 23, 2013 as described previously. Thus, BO 122 may be presented as a horizontal bar extending from start point 122.1 positioned below time periods 131 and 134 to end point 122.2 positioned below time periods 132 and 136. The start point 122.1 may line up with points in the time periods 131 and 134 which approximately correspond to Apr. 14, 2012, and the end point 122.2 may line up with points in the time periods 132 and 136 which approximately correspond to Jan. 23, 2013.

In an embodiment, the GUI 100 may include multiple axes and one or more scales on each of the multiple axes. Each axis (and the associated scale(s)) may represent different BO attributes. Thus, the BO(s) presented on the GUI 100 may be presented relative to the scale(s) on each axis. For example, the scale(s) on an x-axis may represent time periods and the scale(s) on a y-axis may represent price ranges. Consequently, the bars 122, 124, and 126 representing BOs such as business promotion BOs may be displayed based on the BOs' respective business promotion periods and business promotion prices. The length of the bars 122, 124, and 126 may correspond to the business promotion period, and the width of the bars 122, 124, and 126 may correspond to the business promotion price. Similarly, BOs may be displayed relative to three axes by displaying the BOs as 3D bars and varying the length, width, and depth of the bars to correspond to the scale(s) on the three axes. For example, business promotion BOs may be displayed based on the BOs' respective business promotion periods, business promotion prices, and business promotion quantities.

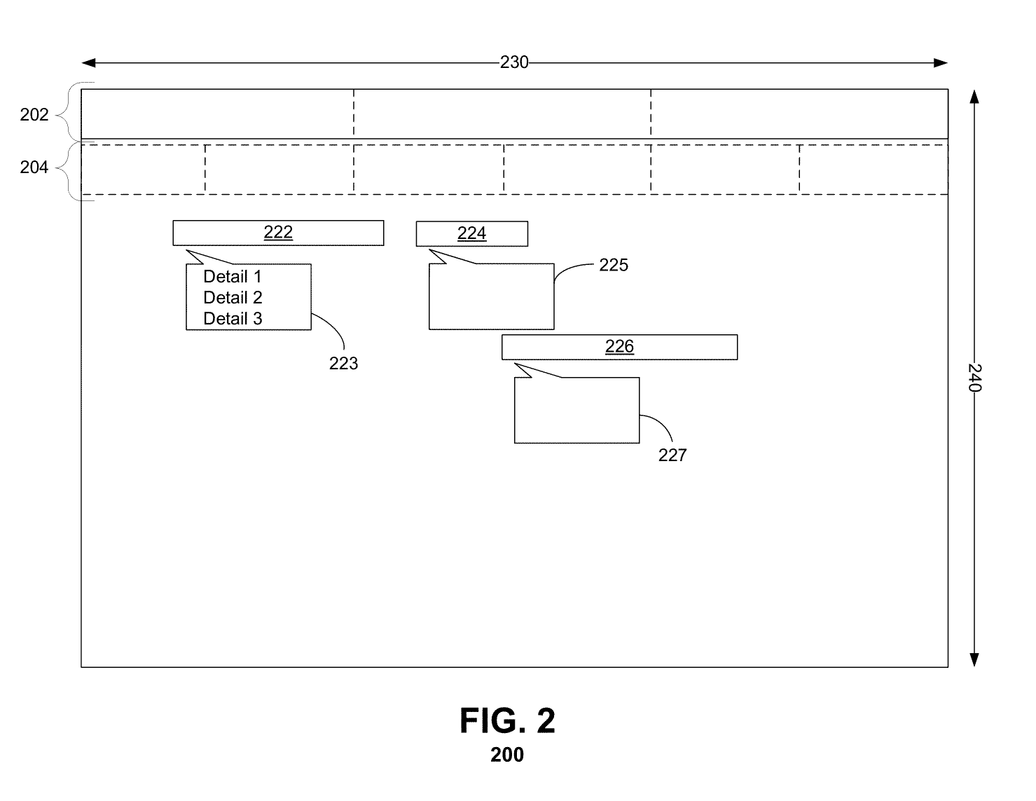

FIG. 2 illustrates a GUI 200 to display BOs according to an embodiment. In an embodiment, BOs may be displayed on a GUI 200 in an organized manner to visually convey information about the BOs. The GUI 200 may display one or more scales 202 and 204 on the x-axis 230 and/or y-axis 240. The GUI 200 may display visual representations of BOs such as 222, 224, and 226 mapped in relationship to the attributes on the x-axis 230 and/or y-axis 240 as discussed in the description pertaining to FIG. 1 above. The GUI 200 may display detail boxes 223, 225, and 227 which present details about BOs associated with BO visual representations 222, 224, and 226 respectively.

In an embodiment, the detail boxes 223, 225, and 227 may display attributes and/or other metadata associated with the respective BOs. The information presented in the detail boxes 223, 225, and 227 may be customized through GUI 200 and/or another GUI so that only the required details are displayed. In an embodiment, the size of the detail boxes 223, 225, and 227 may be customized through GUI 200 and/or another GUI to tweak the readability of the information presented in the detail boxes. In an embodiment, the user may be able to dynamically change the size of a detail box by, for example, selecting the border(s) of the detail box and dragging the border(s) of the detail box to a desired position. The user may select and drag the border(s) of the detail box by, for example, his/her finger (when utilizing a touch screen), a mouse, keyboard, trackball, etc. In an embodiment, all detail boxes 223, 225, and 227 may be displayed without the need for a user to perform any actions on BO visual representations 222, 224, and 226. Specifically, the detail boxes may be displayed without the need for the user to click on or hover a cursor over the BO visual representations 222, 224, and 226.

In a further embodiment, a toggle switch (not shown) may be presented on the GUI 200 to turn on/off the display of detail boxes. Activating the toggle switch when the detail boxes are displayed may remove all detail boxes 223, 225, and 227 from the GUI 200. In addition, the BO visual representations 222, 224, and 226 may be repositioned on the GUI 200 to better utilize the space realized from not displaying the detail boxes 223, 225, and 227. For example, if the detail boxes are no longer displayed, BO visual representation 226 may be moved up on the y-axis 240, while maintaining the same position on the x-axis. Consequently, more space may be made available to display additional content below BO visual representation 226. Activating the toggle switch when the detail boxes 223, 225, and 227 are not displayed may re-display the detail boxes 223, 225, and 227 again. A person having ordinary skill in the art will appreciate that the toggle switch may be implemented in many ways including a button, radio buttons, check boxes, drop down menus, etc. In an embodiment, the toggle switch may not be presented on the GUI 200, but may be implemented through output from a motion sensor within the device displaying the GUI 200. For example, shaking and/or tilting a PC tablet in a particular manner may toggle the display of detail boxes.

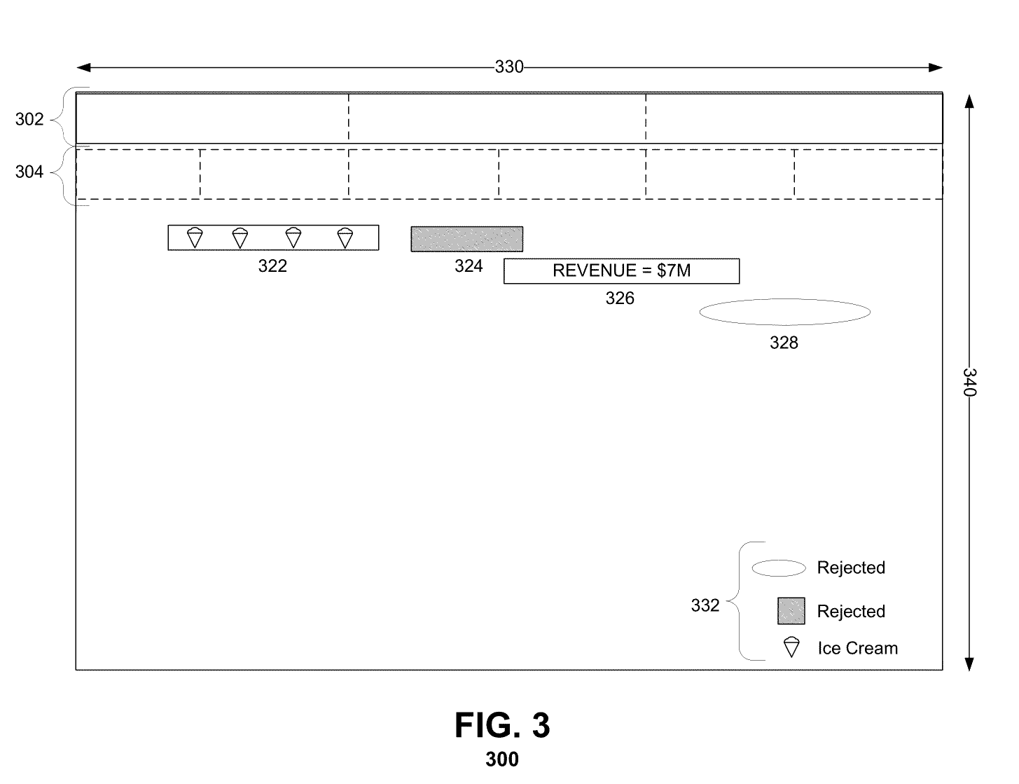

FIG. 3 illustrates a GUI 300 to display BOs according to an embodiment. In an embodiment, BOs may be displayed on GUI 300 in an organized manner to visually convey information about the BOs. The GUI 300 may display one or more scales 302 and 304 on the x-axis 330 and/or y-axis 340. The GUI 300 may display visual representations of BOs such as 322, 324, 326, and 328 mapped in relationship to the attributes on the x-axis 330 and/or y-axis 340 as discussed in the description pertaining to FIG. 1 above. The GUI 300 may display detail boxes (not shown) which present details about BOs associated with BO visual representations 322, 324, 326, and 328 as discussed in the description pertaining to FIG. 2 above.

In an embodiment, visual properties of the visual representations of the BOs 322, 324, 326, and 328 may reflect the attributes and/or metadata of the respective underlying BOs. In an embodiment, the visual representations of BOs may be displayed in different colors and/or patterns based the underlying BOs' attributes/metadata. For example, the BO underlying visual representation 324 may be a proposed business project. An attribute of the underlying proposed business project BO may be in a “rejected” state, indicating that the proposed business project was not approved. All visual representations of proposed business project BOs which were rejected, including 324, may be displayed in a grey color. Similarly, visual representations of all proposed business project BOs which were accepted may be displayed in a green color (not shown). Therefore, a user viewing the GUI 300 may easily distinguish between accepted business projects and rejected business projects. A person having ordinary skill in the art will appreciate that any color may be used to represent different attributes/metadata of BOs including violet, indigo, blue, green, yellow, orange, red, and/or any combination thereof.

In an embodiment, the visual representations of BOs may present images associated with the underlying BOs' attributes/metadata. For example, the underlying BO of visual representation 322 may be a business promotion BO. The business promotion may be for a product such as ice cream. This product information associated with the BO may be reflected by displaying ice cream icons on the visual representation 322 of the BO. Similarly, in an embodiment, the visual representations of BOs may present videos associated with the underlying BOs' attributes/metadata.

In an embodiment, the visual representations of BOs may present text based on the underlying BOs' attributes/metadata. For example, the underlying BO of visual representation 326 may be an automobile company BO. The automobile company may have reported a total revenue for a particular year at 7 million dollars. The total revenue may be an attribute and/or metadata associated with the automobile company BO. This total revenue information may be reflected on the visual representation of the BO 326 by displaying text which states “REVENUE=$7M.” In an embodiment, the text presented in/on a visual representation of a BO may scroll up, down, left, and/or right in the visual representation if the entire text does not fit within the visual representation.

In an embodiment, the visual representations of BOs may be displayed in different shapes based the underlying BOs' attributes/metadata. For example, the BO underlying visual representation 328 may be a proposed business project. An attribute of the underlying proposed business project BO may be in a “rejected” state, indicating that the proposed business project was not approved. All visual representations of proposed business project BOs which were rejected, including 328, may be displayed in an elliptical shape. Similarly, visual representations of all proposed business project BOs which were accepted may be displayed in a circular shape (not shown). Therefore, a user viewing the GUI 300 may easily distinguish between accepted business projects and rejected business projects. A person having ordinary skill in the art will appreciate that any shape may be used to represent different attributes/metadata of BOs including circular, triangular, oval, cubical, spherical, ellipsoidal, etc.

In an embodiment, a visual key to describe the meanings of various visual properties of the visual representations may be displayed on GUI 300 and/or another GUI such as a pop-up window triggered by a user action. For example, the visual key 332 may include information which explains the different meanings associated with certain icons, images, colors, shapes, etc., discussed above. The visual key 332 may indicate that a visual representation with ice cream icons is associated with a BO pertaining to ice cream promotions and that a grey colored and/or elliptical shaped visual representation is associated with a BO in a rejected state.

In an embodiment, a toggle switch (not shown) may be presented on the GUI 300 and/or another GUI to turn on/off the display of the visual key 332. A person having ordinary skill in the art will appreciate that the toggle switch may be implemented in many ways including a button, radio buttons, check boxes, drop down menus, etc. In an embodiment, the toggle switch may not be presented on a GUI, but may be implemented through output from a motion sensor within the device displaying the GUI. For example, shaking and/or tilting a PC tablet in a particular manner may toggle the display of the visual key 332.

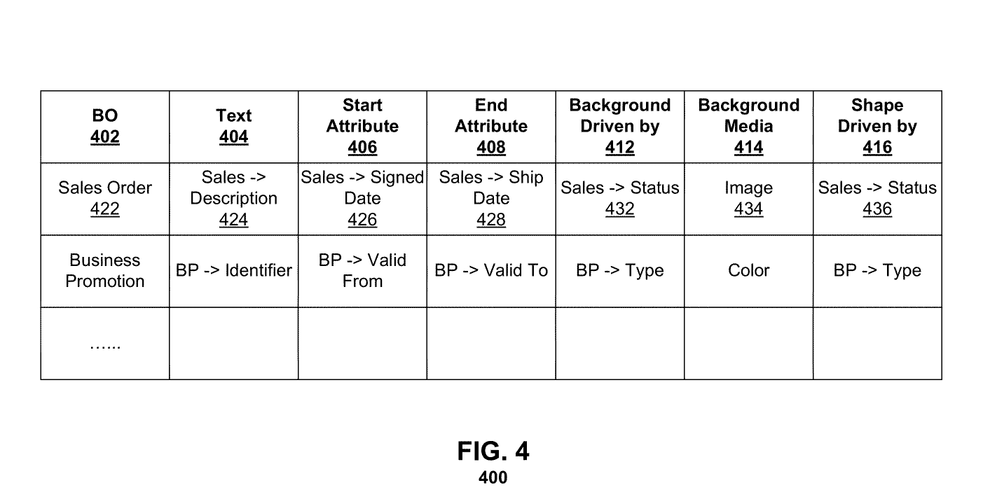

FIG. 4 illustrates an exemplary interface 400 to customize visual representations of BOs according to an embodiment. In an embodiment, the BO attributes/metadata which affect the visual properties of the BO visual representations as discussed in FIGS. 1-3 may be customized through the interface 400. The interface 400 includes a BO column 402 to list the BOs which may be visually represented in a GUI such as GUIs 100-300. For each BO in the BO 402 column, a user may define the text 404 which should be displayed in each BO's visual representation. For example, the user may define that all visual representations of sales order BOs 422 display the description attribute 424 associated with the respective underlying sales order BO. In an embodiment, additional columns (not shown) may be presented in the interface 400 to vary the font and/or font characteristics based on BO attributes/metadata.

In an embodiment, for each BO in the BO 402 column, the user may define a start attribute 406 and an end attribute 408. The start attribute 406 may indicate attributes/metadata associated with a BO which define the start point where a corresponding visual representation should be displayed relative to a scale on an axis as described in the discussion pertaining to FIG. 1. The end attribute may indicate an attribute/metadata associated with a BO which defines the end point where a corresponding visual representation should terminate relative to a scale on an axis as described in FIG. 1.

For example, the user may define that all visual representations of sales order BOs 422 start at a point which corresponds to the signed date 426 of the underlying BO and terminate at the ship date 428 of the underlying BO. In this case, the axis/axes relative which the visual representations are displayed may include a scale which displays time periods.

In an embodiment, for each BO in the BO 402 column, the user may define BO attributes/metadata which drive the background of each BO's visual representation 412 and 414 as described in the discussion pertaining to FIG. 3. For example, the user may define the backgrounds of visual representations corresponding to sales order BOs 422 to be driven by the “status” attribute of the sales order BOs. The status attribute of each sales order BO may be set to one of two possible values. The two possible values may by “in progress” to indicate that the sales order is in the process of being fulfilled and “completed” to indicate that the sales order has been fulfilled. In an embodiment, based on the value of the status attribute, the user may define whether an image, color, video, etc., should be varied in the visual representation of the BO (specified in column 414). For example, the user may define that one or more images displayed within visual representations of sales order BOs should vary based on the attribute which drives the visual representations' backgrounds (412). The user may define that an image displaying the words “in progress” should be displayed in the visual representations if the underlying sales order BOs have a status that is in progress. Similarly, the user may define that videos, colors, patterns, etc., should be varied within the visual representations of BOs based on attributes/metadata associated with the underlying BOs.

In an embodiment, the user may define through interface 400 or another interface (not shown), the image/color/pattern/shape/video which should be associated with particular values of BO attributes/metadata. For example, as explained above, the user may define through interface 400 that the backgrounds of visual representations of sales order BOs 422 should vary based on the underlying BO's status attribute. The status attribute of each sales order BO may be set to one of two possible values. The two possible values may by “in progress” to indicate that the sales order is in the process of being fulfilled and “completed” to indicate that the sales order has been fulfilled. The user may further define the particular colors, patterns, images, shapes, videos, etc., which should be associated with the completed status and the in progress status. The user may define that the completed status is associated with an image displaying the words “completed,” a green color, an elliptical shape, etc. In a further embodiment, the user may associate BO attribute values/metadata with absolute and/or relative paths indicating images, videos, colors, patterns, and/or shapes.

Although the interface 400 is shown in a table format for illustration purposes, a person having ordinary skill in the art will appreciate that the appearance of the interface can vary as long as the interface provides mechanisms to map BO attributes/metadata to visual properties of BO visual representations. In an embodiment, the interface 400 may be any GUI serving as a front-end to one or more databases or other type of storage with BO information/mappings. The interface 400 may include buttons, radio buttons, check boxes, drop down menus, text areas where text may be entered by a user, etc.

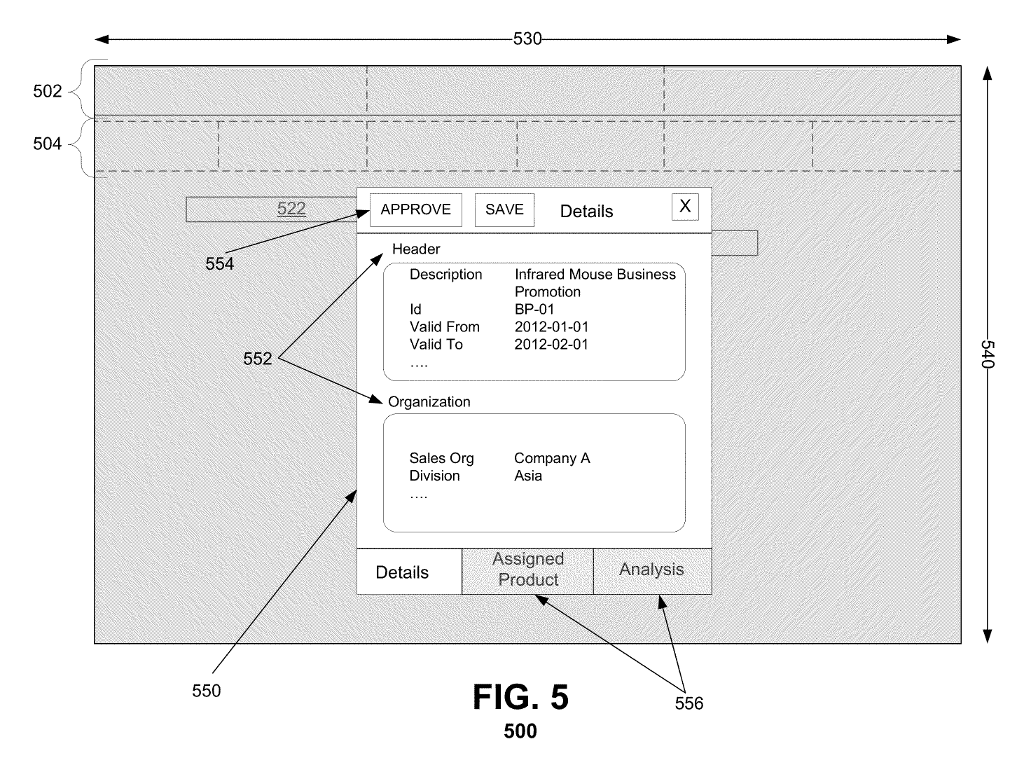

FIG. 5 illustrates a window 550 to display and/or modify attributes/metadata of BOs according to an embodiment. In an embodiment, BOs may be displayed on GUI 500 in an organized manner to visually convey information about the BOs. The GUI 500 may display one or more scales 502 and 504 on the x-axis 530 and/or y-axis 540. The GUI 500 may display visual representations of BOs such as 522 mapped in relationship to the attributes on the x-axis 530 and/or y-axis 540 as discussed in the description pertaining to FIG. 1 above. The GUI 500 may display detail boxes (not shown) which present details about BOs associated with BO visual representation 522 as discussed in the description pertaining to FIG. 2 above. A window 550 may be displayed in response to an action performed on GUI 500. The window 550 may display BO attributes/metadata.

In an embodiment, the window 550 may be displayed based on an action performed on a BO visual representation such as visual representation 522. In response to the action performed on the visual representation 522, the window 550 may display attributes/metadata associated with the BO underlying visual representation 522. For example, the BO underlying the visual representation 522 may be a business promotion BO. The business promotion may be for infrared mice. Therefore, the window 550 may display attributes/metadata such as the description, identifier, valid from date, and valid to date associated with the underlying business promotion BO. In an embodiment, the displayed BO data may be grouped based on type of data. For example, the BO attributes may be grouped into a header section and an organization section 552. The header section may present introductory metadata pertaining to the business promotion and the organization section may present metadata pertaining to the organization offering the business promotion.

In an embodiment, actions may be performed on window 550 to modify the attributes/metadata of an underlying BO corresponding to a visual representation such as visual representation 522. For example, the BO underlying the visual representation 522 may be a business promotion BO. The business promotion may be approved by a user such as a manager. To do so, the user may click via a mouse and/or tap a touch screen to activate the “approve” button 554. In response to activating the approve button 554, the underlying BO's metadata/attributes which keep track of the BO's approval status may be modified to reflect the performed action by the user.

In an embodiment, the window 550 may display additional tabs 556 which may be activated to display additional information pertaining to an underlying BO corresponding to a visual representation such as visual representation 522. In an embodiment, activation of the additional tabs 556 may display additional attributes/metadata pertaining to the underlying BO in an organized manner. For example, the BO underlying the visual representation 522 may be a business promotion BO. Activating an “assigned product” tab 556 may display information pertaining to the product from the business promotion in detail. In an embodiment, activation of the additional tabs 556 may display BO data analysis. For example, activating an “analysis” tab 556 may display a chart or graph with revenue details from the sales of a product during a business promotion.

In an embodiment, the window 550 may be displayed as a pop-up window on top of GUI 500. Visual emphasis may be shifted from the GUI 500 to window 550 by varying the shading, transparency, and/or other visual properties of GUI 500 and/or window 550. In an embodiment, closing window 550 may shift the visual emphasis back to GUI 500 automatically.

A person having ordinary skill in the art will appreciate that activation of displayed elements such as visual representations of BOs, tabs in window 550, and other activatable areas in window 550, may be implemented in many ways including one or more buttons, radio buttons, check boxes, drop down menus, sensors on a touch screen of a device displaying GUI 500 and/or window 550, etc. In an embodiment, activation of displayed elements may be implemented through output from a motion sensor within the device displaying the GUI 500. For example, shaking and/or tilting a PC tablet in a particular manner may activate the displayed elements.

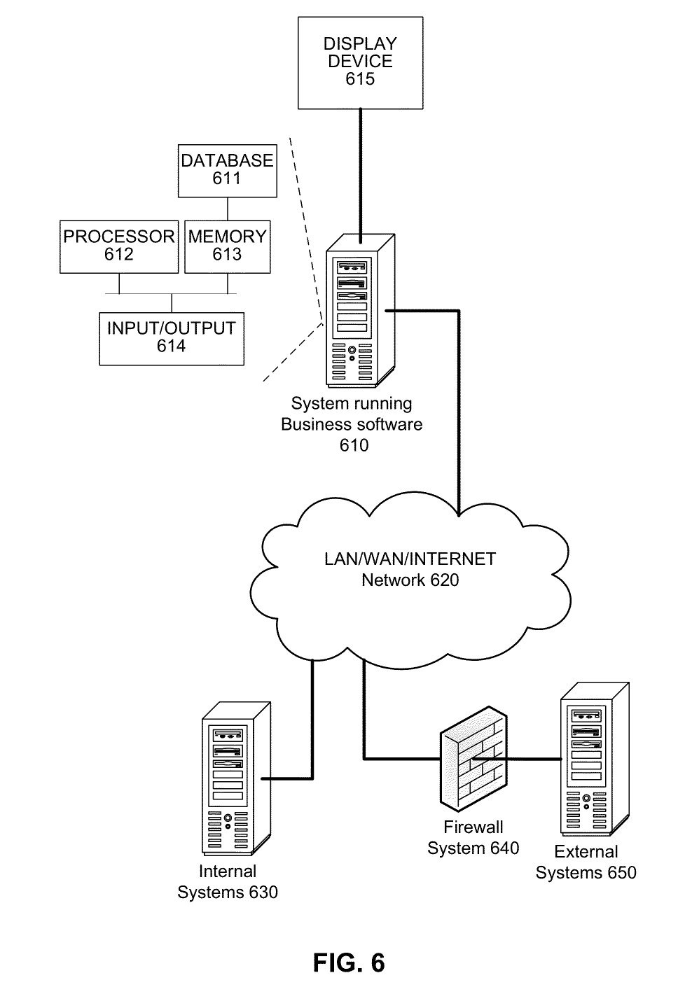

FIG. 6 shows an exemplary architecture in an embodiment of the invention. The system running an application to view, create, or modify BOs 610 may be coupled to a display device 615, existing internal systems 630 through a network 620 and to external systems 650 through the network 620 and firewall system 640. The system running an application to view, create, or modify BOs 610 may include a desktop computer, laptop computer, tablet PC, client computer, mobile phone, central computer in a vehicle, any device with a touch screen, and any other computer. The display device 615 may include a computer monitor, a touch screen, a tablet PC screen, a mobile phone screen, and any other displays. The existing internal systems 630 may include a server and may provide business data and/or other data. The external systems 650 may include a server and may be maintained by a third party, such as an information service provider, and may contain business data and/or other data, that may be updated by the third party on a periodic basis. The system running an application to view, create, or modify BOs 610 may interact with these external systems to obtain updates through a firewall system 640 separating the internal systems from the external systems.

A person having ordinary skill in the art will appreciate that while internal systems 630 and external systems 650 are included in FIG. 6, in some embodiments, one or both of these systems may not be required. In an embodiment, the functionality provided by the internal systems 630 and external systems 650 may be provided by the system running the application to view, create, or modify BOs 610.

Each of the systems in FIG. 6 may contain a processing device 612, memory 613, a database 611, and an input/output interface 614, all of which may be interconnected via a system bus. In various embodiments, each of the systems 610, 630, 640, and 650 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 613 may contain different components for retrieving, presenting, changing, and saving data. Memory 613 may include a variety of memory devices, for example, Dynamic Random Access Memory (DRAM), Static RAM (SRAM), flash memory, cache memory, and other memory devices. Additionally, for example, memory 613 and processing device(s) 612 may be distributed across several different computers that collectively comprise a system.

Database 611 may include any type of data storage adapted to searching and retrieval. The database 611 may include SAP database (SAP DB), Informix, Oracle, DB2, Sybase, and other such database systems. The database 611 may include SAP's HANA (high performance analytic appliance) in-memory computing engine and other such in-memory databases.

Processing device 612 may perform computation and control functions of a system and comprises a suitable central processing unit (CPU). Processing device 612 may comprise a single integrated circuit, such as a microprocessing device, or may comprise any suitable number of integrated circuit devices and/or circuit boards working in cooperation to accomplish the functions of a processing device. Processing device 612 may execute computer programs, such as object-oriented computer programs, within memory 613.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
displaying at least one scale on at least one axis, wherein the at least one scale presents a range of values associated with at least one business object attribute;
displaying at least one visual representation of at least one business object, wherein the at least one visual representation is positioned relative to the at least one scale; and
varying at least one visual property of the at least one visual representation based on information associated with the at least one business object, wherein the at least one visual property is at least one of: a color of the at least one visual representation, a pattern in the at least one visual representation, a video in the at least one visual representation, text in the at least one visual representation, an image in the at least one visual representation, and shape of the at least one visual representation; and
in response to activation of the at least one visual representation, displaying at least a window presenting information associated with the at least one business object.

2. A computer-implemented method comprising:
displaying at least one scale on at least one axis, wherein the at least one scale presents a range of values associated with at least one business object attribute;
displaying at least one visual representation of at least one business object, wherein the at least one visual representation is positioned relative to the at least one scale; and
varying at least one visual property of the at least one visual representation based on information associated with the at least one business object.

3. The method of claim 2, wherein the at least one visual property is at least one of: a color of the at least one visual representation, a pattern in the at least one visual representation, a video in the at least one visual representation, text in the at least one visual representation, an image in the at least one visual representation, and shape of the at least one visual representation.

4. The method of claim 2, wherein the varying is based on a mapping which associates the at least one visual property and at least one value of at least one attribute of the at least one business object.

5. The method of claim 2, further comprising:
displaying a visual key to indicate at least a meaning of the at least one visual property.

6. A computer-implemented method comprising:
displaying at least one scale on at least one axis, wherein the at least one scale presents a range of values associated with at least one business object attribute;
displaying at least one visual representation of at least one business object, wherein the at least one visual representation is positioned relative to the at least one scale; and
in response to activation of the at least one visual representation, displaying at least a window presenting information associated with the at least one business object.

7. The method of claim 6, wherein the at least one visual representation is activated via a touch screen.

8. An apparatus comprising:
a display to:
display at least one scale on at least one axis, wherein the at least one scale presents a range of values associated with at least one business object attribute;
display at least one visual representation of at least one business object, wherein the at least one visual representation is positioned relative to the at least one scale; and
a processor to:
vary at least one visual property of the at least one visual representation based on information associated with the at least one business object.

9. The apparatus of claim 8, wherein the at least one visual property is at least one of:
a color of the at least one visual representation, a pattern in the at least one visual representation, a video in the at least one visual representation, text in the at least one visual representation, an image in the at least one visual representation, and shape of the at least one visual representation.

10. The apparatus of claim 8, wherein the processor varies the at least one visual property based on a mapping which associates the at least one visual property and at least one value of at least one attribute of the at least one business object.

11. The apparatus of claim 8, wherein the display is further configured to:
display a visual key to indicate at least a meaning of the at least one visual property.

12. An apparatus comprising:
a display to:
display at least one scale on at least one axis, wherein the at least one scale presents a range of values associated with at least one business object attribute;
display at least one visual representation of at least one business object, wherein the at least one visual representation is positioned relative to the at least one scale; and
in response to activation of the at least one visual representation, display at least a window presenting information associated with the at least one business object.

13. The apparatus of claim 12, further comprising:
a touch screen to activate the at least one visual representation.

14. A non-transitory computer-readable medium embodied with computer-executable instructions for causing a computer to execute instructions, the computer instructions comprising:
displaying at least one scale on at least one axis, wherein the at least one scale presents a range of values associated with at least one business object attribute;
displaying at least one visual representation of at least one business object, wherein the at least one visual representation is positioned relative to the at least one scale; and
varying at least one visual property of the at least one visual representation based on information associated with the at least one business object.

15. The computer-readable medium of claim 14, wherein the at least one visual property is at least one of: a color of the at least one visual representation, a pattern in the at least one visual representation, a video in the at least one visual representation, text in the at least one visual representation, an image in the at least one visual representation, and shape of the at least one visual representation.

16. The computer-readable medium of claim 14, wherein the varying is based on a mapping which associates the at least one visual property and at least one value of at least one attribute of the at least one business object.

17. The computer-readable medium of claim 14, wherein the computer instructions further comprise:
displaying a visual key to indicate at least a meaning of the at least one visual property.

18. A non-transitory computer-readable medium embodied with computer-executable instructions for causing a computer to execute instructions, the computer instructions comprising:
displaying at least one scale on at least one axis, wherein the at least one scale presents a range of values associated with at least one business object attribute;
displaying at least one visual representation of at least one business object, wherein the at least one visual representation is positioned relative to the at least one scale; and
in response to activation of the at least one visual representation, displaying at least a window presenting information associated with the at least one business object.

19. The computer-readable medium of claim 18, wherein the at least one visual representation is activated via a touch screen.
